(19) United States
(12) Patent Application Publication
(10) Pub. No.: US 2026/0040022 A1
(43) Pub. Date: Feb. 5, 2026

(54) SYSTEM AND METHOD FOR IMMERSIVE MUSICAL PERFORMANCE BETWEEN AT LEAST TWO REMOTE LOCATIONS OVER A NETWORK

(71) Applicant: BONZA MUSIC LIMITED, London (GB)

(72) Inventors: Gavin KEARNEY, York (GB); Helena DAFFERN, York (GB); Patrick CAIRNS, York (GB); Fiona RYDER, London (GB); Alistair AGNEW, London (GB)

(21) Appl. No.: 19/355,979

(22) Filed: Oct. 10, 2025

Related U.S. Application Data
(63) Continuation of application No. PCT/GB2024/050804, filed on Mar. 26, 2024.

(30) Foreign Application Priority Data
Apr. 12, 2023 (GB) 2305329.1

(51) Int. Cl. H04S 7/00

(52) U.S. Cl. CPC H04S 7/304

(57) ABSTRACT

A system and method for immersive musical performance between at least two remote locations over a network A system and method for collaborative musical performance where performers at a first location space and a second location space, remote from the first, can experience a perception of being in the same location. The method/system requires obtaining at least one binaural room impulse response of a desired space (which may or may not be one of the locations), sending a low-latency audio stream of performances in the respective location spaces over a network, and applying the binaural room impulse response (BRIR) as a real-time filter. In this way the sound source from the remote location is perceived as located within the desired space when played back through head phones. In one form, one or both of the location spaces may be divided into zones, where a different BRIR is applied, depending on a position of the zone which corresponds to a position where the BRIR was measured.

### TECHNICAL FIELD

The present invention relates to a system and method for facilitating musical performance between at least two remote locations over a network, e.g. a system and method of creating immersive virtual acoustic spaces in which multiple performers can perform together whilst connected remotely over the internet.

### BACKGROUND TO THE INVENTION

Low-latency network-based software solutions for performing simultaneously at two or more remote locations are known. Particular examples include Soundjack™ and SonoBus™ which enable delivery of a standard stereo audio experience over headphones.

A problem identified in such systems is that participants do not have the perception of performing together in the same space, i.e. a locally situated musician does not feel that the external musicians are in the room with them. This problem stems from the localisation of all sound sources ‘in-head’ due to headphone listening, making it sound and feel unnatural. Particularly, there is no coherence between auditory cues and visual cues when presented on a screen.

Furthermore, even if loudspeakers are used and set up optimally for stereo reproduction at the screen, there is a mismatch between the audio and visual cues if the participant is off-centre from the screen. In the case of loudspeaker reproduction, a large surround sound array is required to create a realistic impression of a shared acoustic environment. Loudspeaker playback further incurs additional latency of approximately 3 ms per metre.

For a performer, the perceived relative position of another performer is even more important than any delay between an audio event and its visual equivalent, such as video of a drum stick hitting a cymbal or snare drum not matching the audio of same.

Examples of remote performance systems known in the field include WO2022/196073 which relies on measurement of binaural room impulse responses (BRIR) from the position of each of the performers in the space. US2022/0114993 discloses a gestural controlled virtual musical instrument. But does not discuss spatial audio, binaural sound or immersive audio. WO2018/116368 discloses a framework of HRTFs, to render directly the performer positions. In general, the computational complexity of the prior art systems are significantly increased with the number of participants.

### SUMMARY OF THE INVENTION

The present invention seeks to address the above problems identified in available systems for performing together over a network. At the least the invention will provide an alternative experience for users seeking to play together (e.g. as a practice or in formal performance) over the internet. The invention has particular application for music education.

A broad aspect of the invention is outlined according to claim 1 of the appended claims.

The invention utilises binauralisation techniques to create an impression for the user that sound sources are located external to the head when listening on headphones. The invention is implemented by taking acoustic measurements in real rooms to capture the sonic signature of the space and using these as real-time filters so that the sound sources are perceived as located within that space. The approach of the claimed invention is notably different to that of the prior art, e.g. WO2022/196073, because the positions of the remote participants are not binauralised directly, but rather their position is presented on a virtual representation of a loudspeaker system. This enables a major advantage, in that the positions of the performers can be defined anywhere within the sound field of the loudspeakers as desired by the end users.

Binaural processing for multiple listeners is undertaken to create immersive virtual spaces. In embodiments, the binaural measurements are pre-processed prior to auralisation, i.e. the procedure designed to model and simulate the experience of acoustic phenomena rendered as a soundfield in a virtualized space. Without this processing, the precedence effect will create strong localisation errors, resulting in an unrealistic experience.

The method of the invention is scalable for any number of participants. For example, mapping of the zones is dependent on the geometry of the reproduction space, not on the number of listeners/participants. In one form, the method can be configured to incorporate the acoustics of both spaces (e.g. external space in the stereo mix and local space in binaural render) or either just the local or external spaces exclusively. According to an aspect of the inventive concept, e.g. as claimed in claim 15, a method utilised herein comprises obtaining a virtual loudspeaker construct of a desired space (e.g. a first location space where performers are to be located and/or another space, e.g. a well-known venue) to provide a sonic signature of said desired space. The virtual loudspeaker construct is obtained by taking a binaural acoustic measurement at a centre of at least one zone in the desired space, relative to at least two loudspeakers. Preferably, there are three speakers, e.g. a left, centre and right speaker. In this way, the virtual loudspeaker construct can be applied as a real-time filter so that the sound source is perceived as located within the desired space when played back through head phones.

The invention may result in a number of benefits, namely:
Realistic musical interaction due to shared virtual spaces and a feeling of immersion in said virtual space by a participant;
The system has particular application for network music education applications, but is not limited to this use;
Spatial separation and locatedness of sound sources allows participants to easily focus on individual players;
Scalable using a ‘zone’ approach to any number of local/remote performers without increase in local rendering complexity;
Enables computationally efficient room simulation and binaural delivery while minimising the required network bandwidth by capping the ‘per site’ bandwidth requirement, e.g. at a minimum of two channels (assuming 1 Mbps per channel per site—˜800 kbps for 48 kHz, 16 bit with ˜200 kbps allowance for other network processes—such as 64 kbps opus compressed tech comms);
Removes air propagation delay from the immersive audio Networked Music Performance, NMP, experience by counting network latency towards initial time gap in auralisation.

### BRIEF DESCRIPTION OF THE DRAWINGS

The present invention will be described by reference to the accompanying drawings, wherein:

FIG. 1 illustrates a conceptual plan view of the invention;

FIG. 2 illustrates a conceptual plan view of a method of implementation in a reproduction framework;

FIG. 3 illustrates an acoustic measurement framework;

FIG. 4 illustrates a conceptual plan view of a method of implementation in a multi-site reproduction framework

FIG. 5 illustrates a pictorial overview of hardware components;

FIG. 6 illustrates an example of audio routing at a single location;

FIG. 7 illustrates an overview of audio processing signal flow;

FIG. 8 illustrates an overview of the UDP audio streaming method;

FIG. 9 illustrates a convolution process utilising a Fast Fourier Transform, FFT, overlap-add method.

### DETAILED DESCRIPTION OF THE INVENTION

The following description presents exemplary embodiments and, together with the drawings, serves to explain principles of the invention. However, the scope of the invention is not intended to be limited to the precise details of the embodiments, since variations will be apparent to a skilled person and are deemed also to be covered by the description. Terms for components used herein should be given a broad interpretation that also encompasses equivalent functions and features. In some cases, several alternative terms (synonyms) for features have been provided but such terms are not intended to be exhaustive.

Descriptive terms should also be given the broadest possible interpretation, e.g. the term “comprising” as used in this specification means “consisting at least in part of” such that interpreting each statement in this specification that includes the term “comprising”, features other than that or those prefaced by the term may also be present. Related terms such as “comprise” and “comprises” are to be interpreted in the same manner. Directional terms such as “vertical”, “horizontal”, “up”, “down”, “upper” and “lower” are used for convenience of explanation usually with reference to the illustrations and are not intended to be ultimately limiting if an equivalent function can be achieved with an alternative dimension and/or direction.

The description herein refers to embodiments with particular combinations of steps or features, however, it is envisaged that further combinations and cross-combinations of compatible steps or features between embodiments will be possible. Indeed, isolated features may function independently as an invention from other features and not necessarily require implementation as a complete combination.

It will be understood that the illustrated embodiments show applications only for the purposes of explanation. In practice, the invention may be applied to many different configurations, where the embodiment is straightforward for those skilled in the art to implement.

The proposed solution utilises a novel framework that facilitates capture and reproduction of acoustic spaces, using a distribution of binaural measurement points around a virtual loudspeaker construct. It is particularly exemplified by two measurement and reproduction paradigms; e.g. “they are here” where external participants to the musical experience are virtually present in the local space; or “you are there” where a shared virtual environment is presented to all parties in the networked music experience. The invention is best explained by reference to the figures and the above concepts.

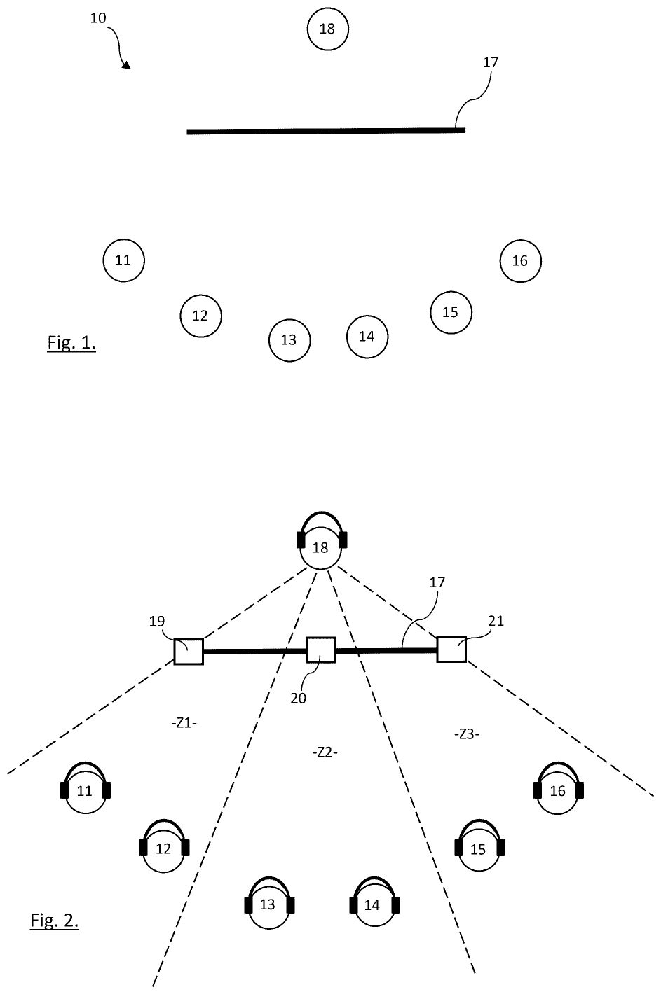

FIG. 1 represents an overview implementation of the invention. For example, a performer conceptual layout 10 is shown, where a group of local performers 11-16, at a first location space, are arranged relative to a display device, e.g. screen 17. At a second location space, remote from the first, one or more remote performers 18 also faces a display device. The conceptual layout 10 represents screen 17 as the same device, but in reality there will be a display device at each end of the network connection, functioning as a “window” between performers, much like in a recording studio with separate rooms for isolating a performance.

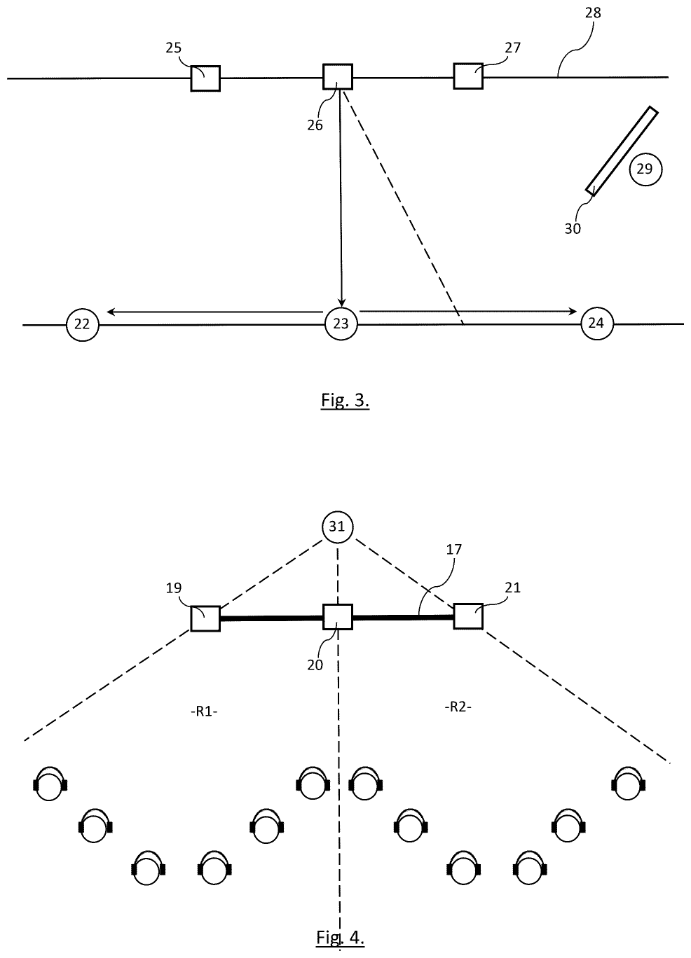

Now referring to FIG. 2, according to a “they are here” method of implementation in a reproduction framework, the active local listening area is divided into listening zones, e.g. three zones Z1, Z2 and Z3 (aka Zone A, B and C), each accommodating pairs of local performers, e.g. 11 and 12, 13 and 14, 15 and 16; although additional performers may join a zone as physical space permits. The screen area 17 is acoustically represented by three virtual loudspeakers, e.g. left 19, centre 20 and right 21. Measurements for these virtual loudspeakers are achieved by binaural acoustic measurement from each loudspeaker to the centre of each listening zone Z1, Z2 and Z3 (as explained with reference to FIG. 3), and ultimately reproduced in headphones by a user, e.g. performer 18 looking through the “window” of screen 17 at a group of remote performers hears a stereo representation based on which zone a performer 11-16 is located.

A two-channel stereo mix of the performer(s) is received at each local reproduction site along with a video signal; although a video signal is not essential to achieving the improved aural experience of the invention. However, with an accompanying video signal, the spatial location of the remote performers at the second location space is therefore placed to match the visual cue, i.e. where a performer is standing. A simultaneous and equivalent transmission is made from the local site to the remote site.

Whilst the stereo mix is transmitted, reproduction is via 3 channels with reinforced centre imaging if the reproduction angles become too large, e.g. subtend greater than ±45 degrees for the left and right virtual loudspeakers, which depends on room geometry. Centre channel extraction is obtained through summation of the L+R channels and mixed to taste, e.g. typically −6 dB for large screen widths. For reproduction angles that subtend less than ±30 degrees, the centre channel is not required and the system may be simplified to two channel only.

According to FIG. 2, all performers 11 to 16 and 18 wear headphones and the binaural presentation is rendered in real time, where they perceive the location of the auditory event to come from the correct position corresponding to musicians on the screen. For example, a remote musician 18 hears the performance of performers 15 and 16 placed in the stereo field toward the left, because, from the perspective of musician 18, performers 15 and 16 in zone Z3 appear to the left of the screen. The simplest form of the invention is where all performers are stationary, however, in some forms performers may be mobile and movement on-screen will be tracked and rendered in the stereo field as panned in the direction of movement in the headphone mix for a local performer. In other words, further forms of the invention may track, by motion sensing means, a remote performer and make real time mix adjustments, e.g. as a performer crosses the stage. In this way, a remote performer that moves from position left to right may cause the mix of the instrument of that performer to pan from hard left to centre.

In an exemplary form, the binaural acoustic measurements are processed so that correct stereo imaging is perceived by a participant, e.g. 18, relative to each listening zone Z1, Z2, Z3. Therefore, a local performer 11, 12 that is standing to the left in front of the screen 17, is perceived by the remote performer 18 to be on the right, compared to a centred mix of performers 13 and 14.

Processing according to the invention involves manipulation of the binaural cues of interaural time and level difference. Without such processing, the precedence effect may create localisation errors in the direction of the nearest virtual loudspeaker. The precedence effect, or law of the first wavefront, is a binaural psychoacoustical effect where, when a sound is followed by another sound separated by a sufficiently short time delay (below the listener's echo threshold), listeners perceive a single auditory event. I.e. the perceived spatial location is dominated by the location of the first-arriving sound (the first wave front) and the lagging sound also affects the perceived location. However, its effect is suppressed by the first-arriving sound.

For optimum use, performers should be located in a fixed position, i.e. should set up instruments facing in the direction of the screen. For example, a pianist sitting at a grand piano and having to move their head between a sideways direction to view a screen and forwards to see their keyboard and play, will have a suboptimal experience since the headphone mix may not account for head rotation. In this case the piano keyboard should be parallel with the screen. However, in a further form of the invention, local Ambisonics rendering, which could utilise a full sphere of binaural measurements, may be implemented which is able to compensate for any head rotation/movement.

Each listening zone Z1, Z2, Z3 has an acoustic sweet spot at the point it was measured, i.e. the experience is most realistic for the observer 18 when the performers 11-16 are located in the zones that correspond to where the measurement was taken. However, the ventriloquism effect holds strongly in each zone to ensure good localisation at the screen. Outside of the zones, the ventriloquism effect is weakened. The ventriloquism effect is an example of where a visual cue overrides other senses such as hearing. In other words, the stereo image does not need to be perfect for a user to realistically perceive a sound as coming from a particular direction if it generally matches the visual cue on the display 17.

An implementation according to the above is scalable for any number of participants. Mapping of the zones is dependent on the geometry of the reproduction space, not on the number of listeners.

In one form, the method may incorporate the acoustics of both spaces, e.g. remote space in the stereo mix and local space in the binaural render, or just the local space (e.g. where remote instruments are close-mic'ed).

In one form, a single binaural diffuse field measurement is also applied/used for local performer monitoring of their own instrument, so they have the impression that their close mic'ed instrument (e.g. a clip-on microphone pointed into the bell of a trumpet) has the room reverberation applied to it as well. Another example would be where an electronic piano keyboard is plugged directly into a computer interface; i.e. ordinarily it would have no room acoustic on it when listened to on headphones, but a diffuse field reverb will provide the desired ambience.

In a second form of the method, referred to as “you are there” above, the same approach is adopted but where acoustic measurements used in the zones are not taken in the actual reproduction environment (i.e. first location space) and, instead or in addition, taken with the correct relative geometry in any desired acoustic environment. Such an environment could be the remote environment of other participants or a completely different acoustic environment like a famous recording studio or venue.

An example method of acoustic measurement framework is illustrated by FIG. 3, where three binaural measurement positions 22, 23, 24, corresponding to the zones Z1, Z2, Z3, are established relative to real loudspeaker positions 25, 26, 27 on a line 28, representing a screen position.

Furthermore, a diffuse field measurement capture 29 may be taken at two to three times a critical distance point. Notably, FIG. 3 is not to scale such that position 29 may be much deeper into the room than shown. Direct sound is attenuated by an acoustic baffle 30 such that the measurement taken at position 29 is a relatively neutral representation of the room reverb. As mentioned above, this neutral reverb may be applied to the performer's own instrument (which may be a mono signal) mixed centrally in their personal monitor mix.

By way of background, the Head Related Transfer Function, HRTF, convolution process requires acoustic measurement of Binaural Room Impulse Response, BRIR, for the space requiring simulation. This may be achieved using a KU100™ or similar binaural dummy head to perform impulse response measurement in the room to be simulated. In an alternative form, Ambisonic impulse response measurements may be captured using a soundfield microphone and converted to binaural representations.

In accordance with known methods of obtaining a sonic signature of the room, three measurements are taken at each of positions 22, 23 and 24 by a binaural measuring device, i.e. a dummy head with stereo microphone(s). A sine sweep tone is emitted from each speaker 25, 26, 27, to excite the air in turn e.g. at the 20 Hz to 20 kHz range of human hearing over approximately 20 seconds each. The length of measurement typically depends on the reverb characteristics of the room. The output is saved as a stereo file, for processing to result in a deconvolved binaural room impulse response. In the example, each position measures a response from the three speaker positions, i.e. nine measurements in total. However, for a narrow field only two speakers (no centre) may be used. In wider fields there may be more than three measurement positions, corresponding to zones (Z1, Z2, Z3 etc.).

During measurement, standing and seated positions should be considered (often dependent on the type of instrument). As mentioned, a measurement at each binaural position 22, 23, 24 is taken relative to a ranging signal/tone emitted from each speaker 25, 26, 27, i.e. three times three measurements.

The specific protocol for measurement herein considers a virtual Left-Centre-Right, LCR, loudspeaker configuration as sound sources. There are three receiver positions 22, 23, 24 defined with reference to the ‘zone’ approach, placing the binaural dummy head facing the centre speaker, i.e. angled with eyes toward the centre speaker 26 when in the outlying positions 22 and 24.

The measured BRIR may be saved as a wav file and used in the convolution processes for binaural room simulation. The BRIR is applied locally in real-time to the incoming low-latency audio signal of the remote performance.

In the case of more than two different sites being utilised in the system, the reproduction scene can be divided accordingly, so as to match split screen visuals or multiple display screens. Screens, serving as “windows” to the remote performers can be arranged to reproduce audio panning for the relevant audio stream. A multi-site reproduction framework is illustrated by FIG. 4, e.g. where a first and second groups of performers, resident at sites R1 and R2 respectively, are spatially positioned relative to a performer 31 at a third site, behind a display screen 17.

It is noteworthy that each group of performers can also have corresponding headphone mixes, based on the spatial positioning of remote performers on their local screen. For example, performers at R2 may see, on their screen, the group R1 on the left, and single performer 31 on the right, with corresponding mixing of the soundfield in their headphone mix. The system simply needs to keep track of relative positions in a location map to apply correct BRIR, stored locally, to the incoming audio stream. Processing is performed locally to minimise latency in the audio stream.

The foregoing description conceptually outlines the invention, i.e. a system and method for delivering acoustic room simulation and binaural audio for a telepresence music network. The system is designed for use between multiple remote locations over the internet where at each location there is at least one musician, e.g. a band or orchestra; such as for music education applications where an instructor may be located remotely from one or more students. The system is scalable by incorporating a ‘zone’ approach.

The system herein utilises low latency audio streaming and rendering methods and may be limited by the capabilities of the public network. By way of example, for best results it is expected that a maximum distance between locations of about 500 km (or 1000 km round trip between sites) is practical to achieve realistic performance conditions. However, the distance is not affected by number of users at a particular location since a single stereo mix is exported from each location after initial parameters are set up. In any event, as communication technology improves the distance limits may increase.

A peer-to-peer streaming method of the type described herein requires bandwidth consumption which scales with the number of audio channels. The preferred embodiment streams two (or four with additional tech channels) between each pair of remote sites, allowing multiple sites to connect within reasonable bandwidth consumption. This is particularly of benefit when more than one musician is at each site, ensuring that the bandwidth consumption does not increase when a musician is added at the site.

Particularly, bandwidth consumption and required network processing power does not scale up with local group size. Instead, the audio engine is designed to provide immersive audio display using the summed stereo image of all remote sites received from the streaming component. This approach is unique in a network music context in that it does not require object based audio (discrete channels, which would make bandwidth unmanageable) between sites, but still delivers binaural playback and binaural room simulation. In this way, immersive audio and room simulation is achieved within low bandwidth streaming constraints.

Furthermore, the audio engine can be programmed in such a way that only one instance of the audio rendering processes is required, in contrast to spawning new audio rendering processes for each discrete remote performance group. This novel approach allows processing requirements to be controlled within sensible levels, e.g. achievable on home computers or embedded devices.

It is also noteworthy that a zone-based approach to rendering binaural audio allows good localisation for performers without the need to render a discrete mix for each individual musician. By taking advantage of the ventriloquism effect, performers experience accurate directional sound from visual cues of counterpart musicians displayed in a screen. This ensures that no hardware or digital routing and processing changes need to be made when a new musician is added to the group at each site/zone. This also avoids an audio processing load which would scale up with group size.

An audio rendering method (e.g. BRIR convolution) is needed in the present context since a partitioned overlap-add method allows for immersive audio processing to be achieved with minimal additional latency, which is critical to minimise in immersive audio contexts. Essentially, the system introduces binaural immersive audio room simulation to a performance experience, so that said experience is improved and networked musical interactions made more natural by simulating the experience of playing ‘in the room’ with remote musicians. It is also noteworthy that rendering over headphones, rather than loudspeakers, reduces latency due to sound propagation in air (i.e. the speed of sound).

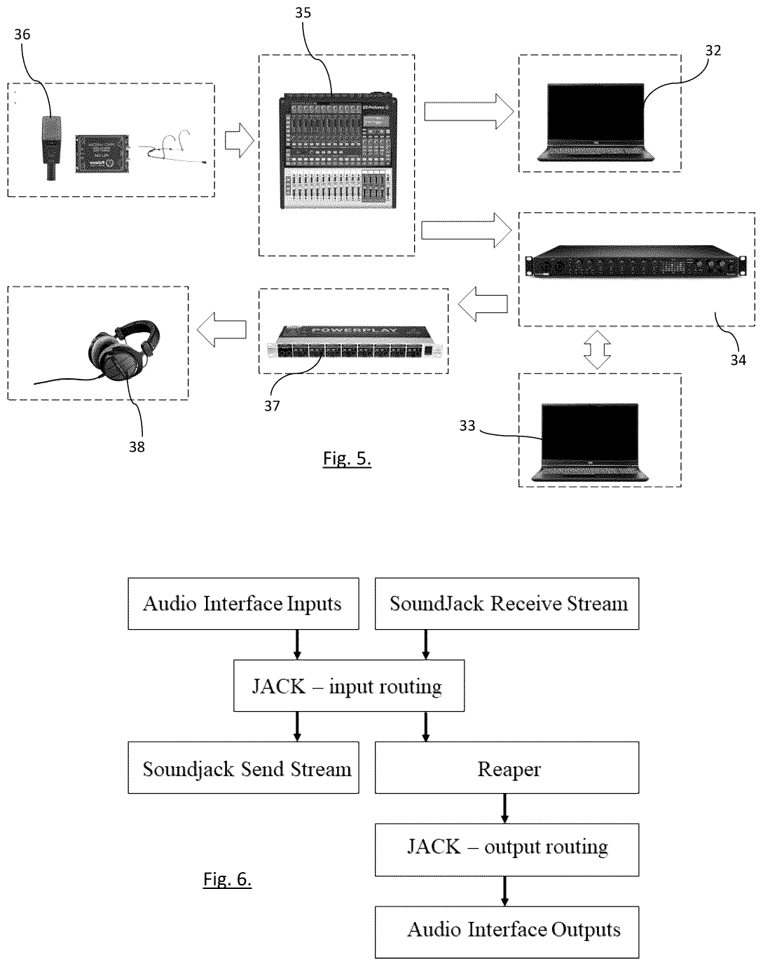

FIG. 5 illustrates an overview of exemplary hardware components, e.g. at each location, comprising: a first (optional) computer 32 used for recording a local group performance; a second computer 33 used for audio rendering and networking processes; an audio interface 34 used to provide audio input and output from second computer 33; a mixing console, mixer 35, for receiving inputs from microphone(s) 36 or Dis capturing the local performance group. Mixer 35 sends a stereo mix with additional auxiliary sends to second computer 33 via audio interface inputs. In the exemplary form, mixing/panning is undertaken from the perspective of a camera, which will correspond to what a remote user sees on their display screen.

One or more headphone amplifiers 37 may be provided, each of which receives a binaural zone mix from the audio interface 34 output for playback by a headphone 38, one for each member of the local performance group. Locally, each performer may receive a separate monitor mix that includes panning of their fellow local musicians depending on relative location. These require additional audio signals, but all is undertaken locally and not streamed over the communication network. Each local performer otherwise receives the same stereo mix of the remote component in their monitor mix, because each performer generally sees the same image in the display screen in front of them.

Further to the illustrated equipment, as mentioned a video camera may capture an image from a selected vantage point (which determines panning), for low latency streaming via computer 33 or a separate computer. The video feed may be integrated with the present system or operate independently, i.e. use an available video conferencing platform such as Zoom™, Skype™ or Teams™.

Example equipment for a single location is outlined in table 1 below:

TABLE 1
Hardware

| | Quan- | | Example | |
|---|---|---|---|---|
| Item | tity | Description | Model | Note |
| Computer | 2 | 1 × Recording | Intel ™ i5 | |
| | | computer | or similar | |
| | | 1 × Audio and | 16 GB | |
| | | network process | DDR4 | |
| | | computer | | |
| Audio | 1 | Audio input and | Focusrite ™ | Recommend |
| Interface | | output for audio | Scarlet ™ | 8ch interface |
| | | and network | 18i20 or | |
| | | process computer | similar | |
| Desk | 1 | Audio mixing for | Presonus ™ | Recommend |
| | | local performance | studiolive or | 16ch desk |
| | | group | similar | with multiple |
| | | | | aux sends |
| Headphone | 1-3 | Amplifying | Behringer ™ | 1-3 will be |
| (HP) | | binaural audio | HA8000 or | required |
| Amplifier | | for HP playback | similar | (depending |
| | | | | on performance |
| | | | | group size |
| | | | | and additional |
| | | | | HP monitors) |

Examples of software components may comprise: a JACK™ audio connection kit used to route audio between applications; a digital audio workstation, DAW, such as Reaper™ used to host audio processing; a convolution plug-in such as X-MCFX™ convolver, used to provide real-time convolution functionality at the DAW; and Soundjack™, used to provide low-latency audio streaming functionality over a communication network.

FIG. 6 illustrates an example of audio routing at one location. Firstly, the audio interface input (e.g. receiving a stereo mix of local performance from the mixer 35, as captured by microphones 36) is routed by audio router software directly to the low-latency audio stream and sent to a remote location; while the incoming low-latency audio stream from the remote location is routed to a DAW for application of a convolution plug-in based on the modelled space. Since, in an exemplary form, there are a separate set of binaural IRs for each zone in a map of the virtual space, the incoming stereo feed is rendered with each zone's corresponding binaural IRs. The processed audio output is routed to the audio interface outputs and onwards for distribution to the performers at that location, e.g. via headphone amplifier 37 and head phones 38. There may be multiple stereo monitor mixes depending on the zone in which the performer is located.

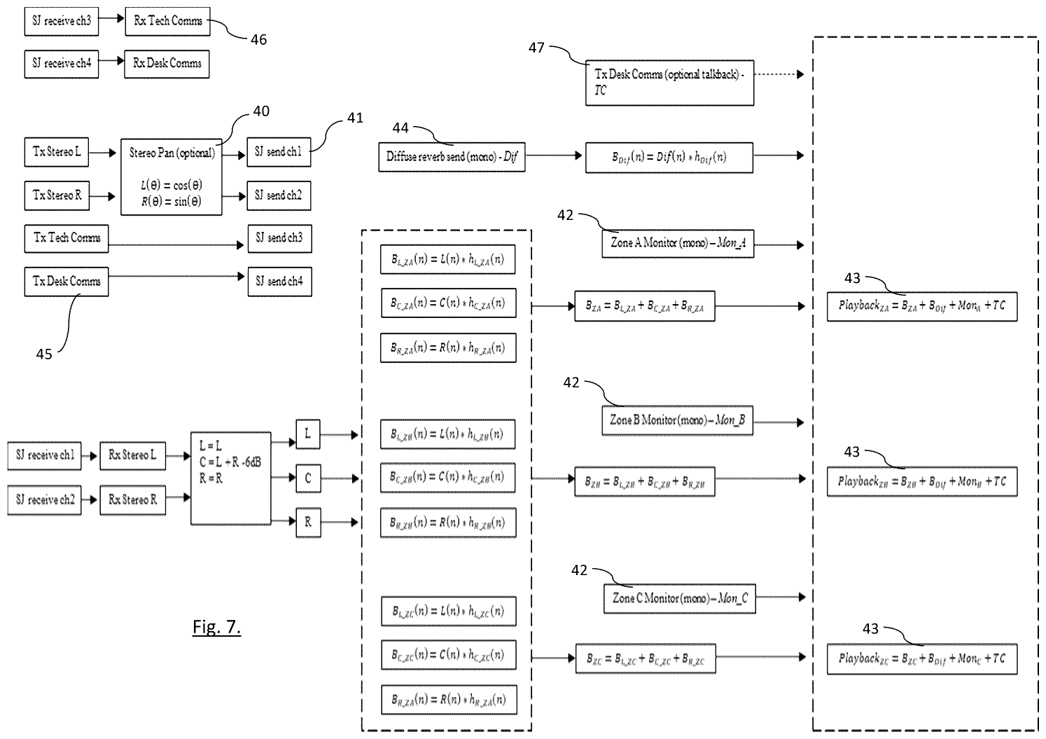

FIG. 7 illustrates an overview of audio processing signal flow. For example, a stereo mix is received at block 40 representing the local performance group from the desk (35). This will be transported to remote sites for auralisation, e.g. via Soundjack™ 41.

A stereo mix is received at a site, representing the combined stereo image of remote performance groups on screen. A mono monitor mix 42 is also received for each zone from the desk (i.e. three in total). This will be added to the binaural playback signal 43 for each relevant zone representing a virtual ‘stage wedge’ monitor.

A mono diffuse reverb send 44 is received from the desk, which will provide binaural simulation of the local performance group to be added to each zone mix for headphone playback 43.

Two private comms channels 45 may be received from the audio interface inputs and passed to the streaming component for utility. The audio engineer at the desk will then be able to talk to remote sites through the main mix. The microphone signal can also be input to the audio interface, in order to add a ‘punch-in’ option to the local audio mix.

At block 46, two private comms channels are received from remote sites from the audio streaming component. These are routed at block 47 to relevant head phone playback via audio interface outputs.

By way of background, an exemplary form of the audio streaming component of the system provides low-latency transport of Pulse Code Modulation, PCM, audio, e.g. Soundjack™. However, the system can be configured for use with any suitable network music system which follows a low latency streaming method, acting as an insert between the audio streaming application input/output buffers and system capture/playback buffers.

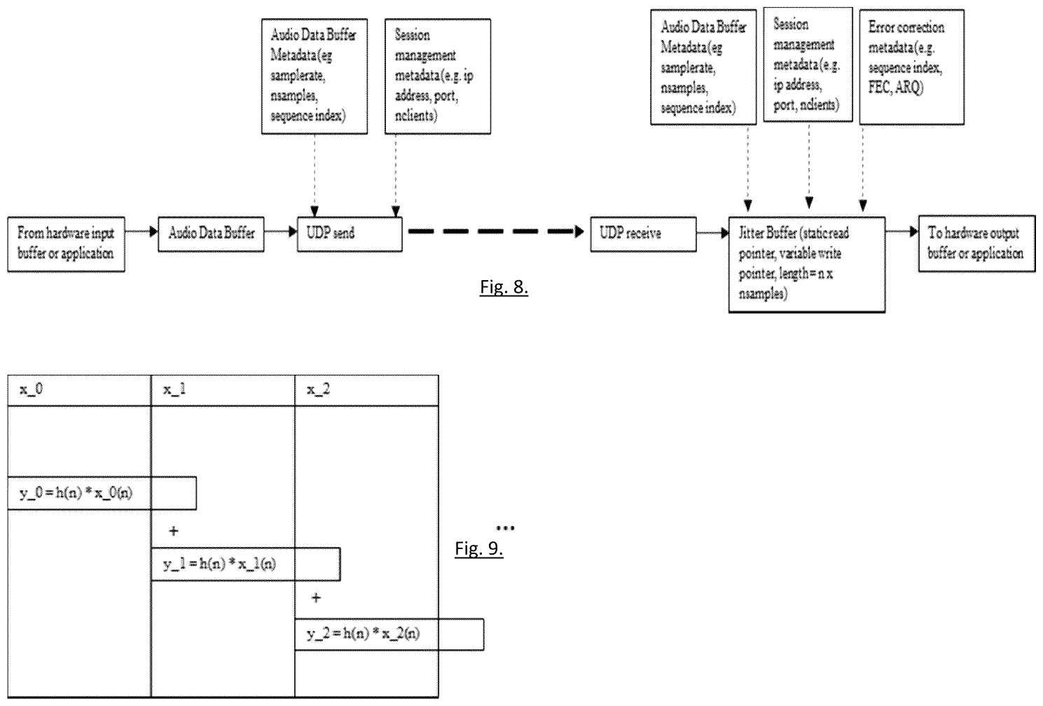

The audio streaming method follows a common User Data Protocol, UDP, streaming design such as described in: XU, AOXIANG & COOPERSTOCK, JEREMY, (2002) “Real Time Streaming of Multi-channel Audio Data over Internet” 5120 (1-3); or CHAFE, CHRIS, SCOTT WILSON, RANDAL J. LEISTIKOW, DAVE CHISHOLM AND GARY P. SCAVONE, (2000) “A Simplified Approach To High Quality Music And Sound Over IP”. Notably, the application used in system development, Soundjack™, benefits from webGUI and server management of session metadata. An overview of the UDP audio streaming method is provided by FIG. 8.

By way of background, a JACK™ Audio Connection Kit (JACK is a recursive acronym), able to provide real-time low-latency connections for both audio and MIDI data between applications, was used for routing between applications in a system according to the invention. This allows hosting of audio processes in a DAW such as Reaper™ JACK v1.9.10 was used, with connections between hardware buffers and applications established or removed using the commands cjack connect) and cjack disconnects Notably, for audio applications to be used with JACK, it is required to set the audio device to Jackrouter in the application settings.

By way of background, the DAW selected for use to implement the invention was Reaper™ but numerous alternative solutions are possible. A DAW is generally able to host features such as channel routing, channel gains, channel summing and convolution. The convolution process itself was performed using measured HRTFs and the XMCFX™ convolver VST plug-in. This convolution process uses a Fast Fourier Transform, FFT, overlap-add method, where the first partition is computed in the time domain to provide zero-latency throughput. For example, according to FIG. 9, for each output frame y(n) the first partition should be computed in the time domain up to the overlap region. The number of terms (samples) in the overlap region may be computed based on the length of the impulse response h(n). The overlap region from each y(n) frame may be computed using FFT methods. Alternatively all y(n) may be computed using FFT methods while accepting at least one audio buffer of process latency. It is noteworthy that an implementation of the system may combine each of the features, offered by the third party examples referred to herein, in a single platform.

Variations of implementing the invention may include providing a pre-defined virtual space where room ambience is measured/known and a user/controller is able to select where a performer is to be located, thereby assigning an appropriate headphone mix to that performer.

It may be appreciated that a location for measurement can be chosen as the “best sounding location” for application as a convolution reverb or a user can choose an entirely different location like a famous theatre to set the performance. In a further alternative, an entirely artificial reverb could be used to simulate the acoustic environment.

In certain forms there may be a provision for each user to tailor their personal monitor mix to whatever location they desire, including the location of fellow musicians within the same local space.

The system and method may be summarised as a collaborative musical performance tool where performers at a first location space and a second location space, remote from the first, can experience a perception of being in the same location. The method/system requires obtaining at least one binaural room impulse response of a desired space (which may or May not be one of the locations), sending a low-latency audio stream of performances in the respective location spaces over a network, and applying the binaural room impulse response (BRIR) as a real-time filter. In this way the sound source from the remote location is perceived as located within the desired space when played back through head phones. In one form, one or both of the location spaces may be divided into zones, where a different BRIR is applied, depending on a position of the zone which corresponds to a position where the BRIR was measured.

1. A method for creating an immersive acoustic environment from assembling collaborative audio events occurring at a first location space and a second location space, the method comprising:
dividing the first location space into a plurality of zones in which audio signals can be generated;
obtaining a virtual loudspeaker construct of at least the first location space and/or another space, also divided into a plurality of zones, to provide a sonic signature of a desired space, wherein the virtual loudspeaker construct assigned to each zone is obtained by binaural acoustic measurement from at least two loudspeakers to the centre of a respective zone;
sending over a communication network, via a low-latency audio stream, an audio signal of one or more sound sources generated in the zones to the second location space and vice-versa;
upon receipt of the audio signal at the first location space and/or the second location space respectively, applying the virtual loudspeaker construct assigned to a respective zone as a real-time filter so that the sound source is perceived as located within that zone of the desired space when played back through head phones.

2.-3. (canceled)

4. The method of claim 1, wherein the step of obtaining the virtual loudspeaker construct comprises:
recording binaural acoustic measurements in the at least first location space; or
one of making and retrieving a corresponding recording of another space.

5. The method of claim 1, wherein the received audio signal is combined with one or more audio signals obtained from local sound sources; and
wherein a diffuse field measurement is obtained and applied as an impulse response to the one or more audio signals obtained from local sound sources.

6. (canceled)

7. The method of claim 1, further comprising:
sending over a communication network, a video stream captured in the first location space to the second location space and vice-versa; and
displaying same on a display device.

8. The method of claim 7, wherein placement of the one or more sound sources, within a stereo mix and applied with the virtual loudspeaker construct, corresponds to a visual placement of the sound source in the displayed video stream.

9. The method of claim 7, wherein the display device is configured for split screen visuals or there are multiple adjacent display screens.

10. A system for collaborative musical performance between performers at a first location space and at least a second location space, each location space comprising:
a sound capture device;
at least one pair of head phones;
an audio interface;
at least one processor configured for audio processing and sending/receiving low-latency audio streaming over a communication network;
wherein the audio processing comprises applying a binaural room impulse response as a real-time filter on an incoming low-latency audio stream, to implement the virtual loudspeaker construct, so that a captured sound source is perceived as located within the desired space when played back through the at least one pair of head phones; and wherein
the system is arranged:
to create an immersive acoustic environment from assembling collaborative audio events occurring at the first location space and the second location space by:
dividing the first location space into a plurality of zones in which audio signals can be generated;
obtaining a virtual loudspeaker construct of at least the first location space and/or another space, also divided into a plurality of zones, to provide a sonic signature of a desired space, wherein the virtual loudspeaker construct assigned to each zone is obtained by binaural acoustic measurement from at least two loudspeakers to the centre of a respective zone;
sending over a communication network, via a low-latency audio stream, an audio signal of one or more sound sources generated in the zones to the second location space and vice-versa;
upon receipt of the audio signal at the first location space and/or the second location space respectively, applying the virtual loudspeaker construct assigned to a respective zone as a real-time filter so that the sound source is perceived as located within that zone of the desired space when played back through headphones.

11. The system of claim 10, further comprising a camera and a display device at each location, and the at least one processor is further configured to stream video over a communication network.

12. The system of claim 11, configured such that placement of the captured sound source, within a stereo mix and applied with the virtual loudspeaker construct, corresponds to a visual placement of the sound source in the displayed video stream.

13. (canceled)

14. The system of claim 11, further comprising means to sum together incoming stereo streams from remote location spaces with locally captured sound sources.

15. A method of obtaining a virtual loudspeaker construct of a desired space, comprising:
taking a first binaural acoustic measurement, at a centre of at least one zone in the desired space, relative to a first loudspeaker;
taking a second binaural acoustic measurement, at the centre of the at least one zone, relative to a second speaker displaced from the first loudspeaker;
preparing a binaural room impulse response (BRIR) from the first and second measurements.

16. (canceled)

17. The method of claim 15, wherein there are at least three zones in the desired space, such that binaural acoustic measurements are repeated for each loudspeaker at a centre of each zone.

18. (canceled)

19. The method of claim 1, wherein creating the immersive acoustic environment comprises implementing collaborative musical performance between performers at both the first location space and the second location space.

20. The system for collaborative musical performance according to claim 10, wherein obtaining the virtual loudspeaker construct comprises one of:
recording binaural acoustic measurements in the at least first location space;
retrieving a corresponding recording of another space; and
making a corresponding recording of another space.

21. The system for collaborative musical performance according to claim 10, wherein the system includes:
means for combining the received signal with one or more audio signals obtained from local sound sources, and
means for obtaining a diffuse field measurement is obtained, and
means for applying the diffuse field measurement as an impulse response to the one or more audio signals obtained from local sound sources.

22. An audio engine arranged to process audio signals generated from a plurality of different sound sources to generate an output for auralisation, wherein the plurality of different sound sources are at at least two separated locations and where each location includes one or more distributed sound sources, the audio engine including:
a real-time filter configured to manipulate binaural cues of interaural time and level differences to deliver a plurality of virtual loudspeaker constructs, wherein each virtual loudspeaker construct reflects a modelled sonic signature of a particular zone at one of said two locations in which sound sources are distributed, and the virtual loudspeaker construct is developed based on binaural acoustic measurement of at least two loudspeakers to the centre of the particular zone, and wherein
the audio engine is arranged to create a soundfield of an immersive virtual space in which the plurality of virtual loudspeaker constructs collectively create, for speakers, an impression that different sound sources are displaced zonally from one another in the soundfield.

23. The audio engine of claim 21, where each location includes a plurality of zones across which one or more distributed sound sources are distributed, and
the speakers are within a headphone environment and the audio engine is arranged to create the impression that:
different sound sources are located externally and different sound sources are displaced zonally from one another in the soundfield.
